(19) United States
(12) Patent Application Publication
(10) Pub. No.: US 2015/0039837 A1
(43) Pub. Date: Feb. 5, 2015

(54) SYSTEM AND METHOD FOR TIERED CACHING AND STORAGE ALLOCATION

(71) Applicant: CONDUSIV TECHNOLOGIES CORPORATION, Burbank, CA (US)

(72) Inventors: Gary Quan, Sylmar, CA (US); Basil Thomas, Santa Clarita, CA (US); Richard Cadruvi, Simi Valley, CA (US); Kalindi Panchal, Northridge, CA (US); Bidin Dinesababu, Stevenson Ranch, CA (US)

(21) Appl. No.: 14/199,449

(22) Filed: Mar. 6, 2014

Related U.S. Application Data
(60) Provisional application No. 61/773,340, filed on Mar. 6, 2013.
(60) Provisional application No. 61/824,076, filed on May 16, 2013.

(51) Int. Cl. G06F 12/12; G06F 12/08

(52) U.S. Cl. CPC G06F 12/122; G06F 12/0871; G06F 2212/604; G06F 2212/69
USPC 711/136

(57) ABSTRACT

Method for data placement in a tiered caching system and/or tiered storage system includes: determining a first period of time between each access to a first data, in a predetermined time window; averaging the first periods of time between each access to obtain an average first period of time; determining a second period of time between each access to a second data, in said predetermined time window; averaging the second periods of time between each access to obtain an average second period of time; comparing the average first period of time and the average second period of time; placing the first data in a fast-access storage medium, when the average first period of time is less than the average second period of time; and placing the second data in the fast-access storage medium, when the average second period of time is less than the average first period of time.

### CROSS-REFERENCE TO RELATED APPLICATIONS

This patent application claims the benefits of U.S. Provisional Patent Application Ser. No. 61/773,340, filed on Mar. 6, 2013 and entitled “System And Method For Tiered Caching”; and U.S. Provisional Patent Application Ser. No. 61/824,076, filed on May 16, 2013 and entitled “System And Method For Tiered Storage Allocation” the entire contents of which are hereby expressly incorporated by reference.

### FIELD OF THE INVENTION

The present invention relates generally to storage management; and more particularly to a system and method for tiered caching and storage allocation.

### BACKGROUND

A cache medium is commonly used by a computer system to reduce the average access time to (main or disk/secondary) memory. A cache medium is a smaller and faster storage medium than the main memory, which stores copies of the data from for example, the most frequently used main memory locations. The more the memory accesses are cached memory locations, the closer the average latency of memory accesses will be to the cache latency than to the latency of main (or secondary) memory. A processor first checks to see if a copy of data is in the cache, when it wants to read from or write to a location in main memory. If so, the processor reads from or writes to (or keeps the data in) the cache, which is much faster than reading from or writing to main memory.

Data is transferred between memory and cache typically in blocks of fixed size. When the data block is copied from memory into the cache, a cache entry is created. The cache entry includes the copied data and the requested storage location. When the processor needs to read or write a location in main memory, it first checks for a corresponding entry in the cache. The cache checks for the contents of the requested memory location in any cache lines that might contain that address. When the processor finds that the memory location is in the cache, this is called a cache hit. Likewise, when the processor finds that the memory location is not in the cache, this is called a cache miss. When a cache hit occurs, the processor immediately reads or writes the data in the cache line. Similarly, when a cache miss occurs, the cache may allocate a new entry, and copies in data from main memory. Then, upon need, if the data is in the cache, the request is fulfilled from the data in the cache.

The proportion of accesses that result in a cache hit is known as the hit rate, and can be a measure of the effectiveness of the cache for a given program or algorithm. However, the existing caching systems do not take into account a significant number of file, system and environment attributes that can improve the hit rate of a caching system.

With increasing popularity of cloud computing, data storage technology is fast moving towards Network Attached Storage (NAS) and a Storage Area Network (SAN), from a direct attached storage model (DAS). The NAS and DAS storage technology provide network means for connecting computer applications to storage systems/devices. However, since there can be a variety of different storage devices with different read and write access times, spin-up time, device boot up time, data recovery and other attributes, the application should be able to take advantage to these different devices for storage of data with different attributes.

Furthermore, when requested to store a file, file systems generally use any storage locations that are available or free at the time of the requests. The file systems typically select from the available storage locations regardless of the types of files that are being stored. Thus, a wide variety of file types (e.g. executables, shared binaries, static data files, log files, configuration files, registry files, etc. that are used by an operating system or software application) are simply stored to storage locations that are available at the time.

However, this method of file assignment results in, for example, portions of available storage in a computing system failing long before other portions of the available storage. Furthermore, a file or data blocks that is accessed infrequently may be stored in the fastest or most responsive storage locations, whereas data blocks or a file that is frequently accessed may be stored in a low speed storage location.

### SUMMARY

In some embodiments, the present invention is a system and method for tiered caching. The invention determines one or more attributes related to a file, block of data, and/or file systems and based on the determined one or more attributes, stores, keeps or removes the most effective data in the cache to be used by a processor.

In some embodiments, the present invention is a system and method for tiered storage allocation. The invention determines one or more attributes related to data, a file and/or file systems and based on the determined one or more attributes, stores, keeps or removes the data in the most effective storage system/device, including, but not limited, to direct attached and networked storage systems.

In some embodiments, the present invention is a method for data placement in a tiered caching system and/or tiered storage system. The computer implemented method includes: determining a first period of time between each access to a first data, in a predetermined time window; averaging the first periods of time between each access to obtain an average first period of time; determining a second period of time between each access to a second data, in said predetermined time window; averaging the second periods of time between each access to obtain an average second period of time; comparing the average first period of time and the average second period of time; placing the first data in a fast-access storage medium, when the average first period of time is less than the average second period of time; and placing the second data in the fast-access storage medium, when the average second period of time is less than the average first period of time.

The computer implemented method may be implemented by storing instructions in a storage medium to perform the method.

### BRIEF DESCRIPTION OF THE DRAWINGS

FIG. 1 is an exemplary simplified system block diagram for tiered caching management, according to some embodiments of the present invention.

FIG. 2 is a block diagram of an exemplary computer system, according to some embodiments of the present invention.

FIG. 3 is an exemplary simplified system block diagram for tiered storage management, according to some embodiments of the present invention.

FIG. 4 is an exemplary process flow for tiered caching, according to some embodiments of the present invention.

FIG. 5 is an exemplary process flow for tiered storage, according to some embodiments of the present invention.

FIG. 6 is an exemplary process flow for data placement, according to some embodiments of the present invention.

### DETAILED DESCRIPTION

The present invention is directed to a system and method for determining one or more attributes related to data, for example, a file and/or file systems, and based on the determined one or more attributes, place the data (file) in a memory. The placement of the data may be caching the data in a fast (cache) memory, and/or saving the data in a tier storage medium.

In some embodiments, the present invention is a system and method for tiered caching. The invention determines one or more attributes related to data, a file and/or file systems and based on the determined one or more attributes, stores, keeps or removes the most effective data in the cache to be used by a processor.

In some embodiments, the present invention is a system and method for tiered storage allocation. The invention determines one or more attributes related to data, a file and/or file systems and based on the determined one or more attributes, stores, keeps or removes the data in the most effective storage system/device, including, but not limited, to direct attached and networked storage systems.

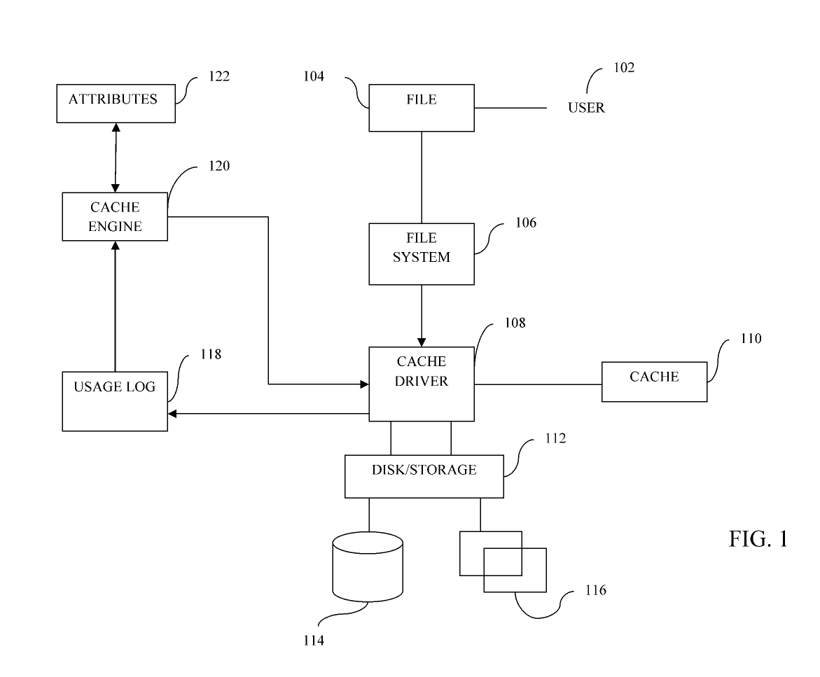

FIG. 1 shows an exemplary system 100 for managing cache storage management and allocating the most appropriate data to a cache based on some file attributes, according to some embodiments of the present invention. As shown in FIG. 1, system 100 includes a file system 106, a cache driver 108, a cache medium (memory) 110, a disk/secondary storage driver 112, a cache engine 120 and one or more storage media, for example one or more disk drives 114, one or more SSD memories 116, and possibly other types of storage media. The cache memory 110 may include different level/types of memory components, such as a combination of RAMs and SSDs. The system 100 may also include other components which, although not shown, may be used for implementation of one or more embodiments. Each of these components may be located on the same device or may be located on separate devices coupled by a network (e.g., Internet, Intranet, Extranet, Local Area Network (LAN), Wide Area Network (WAN), etc.), with wired and/or wireless segments or on separate devices coupled in other means. In some embodiments of the invention, the system (100) is implemented using a client-server topology. In addition, the system may be accessible from other machines using one or more interfaces. In some embodiments, the system may be accessible over a network connection, such as the Internet, by one or more users. Information and/or services provided by the system may also be stored and accessed over the network connection.

Files 104 created or being used by a user 102 are managed by the file system 106 (or a storage system) and sent to the disk/secondary storage driver 112 for storage in or data retrieval from the storage media, via the cache driver 108. The cache driver 108 manages a cache storage 110 and stores the most appropriate data in the cache 110 for future use by the file 104 and the file system 106. Cache 110 is a fast solid state memory, such as dynamic random access memory (DRAM), although other fast memories can be used instead of or in combination with a DRAM. The cache is typically a smaller, faster memory which stores copies of the data from, for example, the most frequently used main memory locations. The cache driver 108 compiles a usage log 118 of the cache data including the application or the operating system that handled (requested) the data, the time of the data request, the time it took the data request to be processed, cache hits on data, time of data in the cache, data removed from the cache, and the like. The usage log 118 is then used by the cache engine 120 to generate a variety of different attributes 122. The generated attributes are then used by the cache driver 108 to cache the data into or remove the cached data from the cache memory 110. Some types of attributes 122 that are used by some embodiments of the present invention are explained in more detail below.

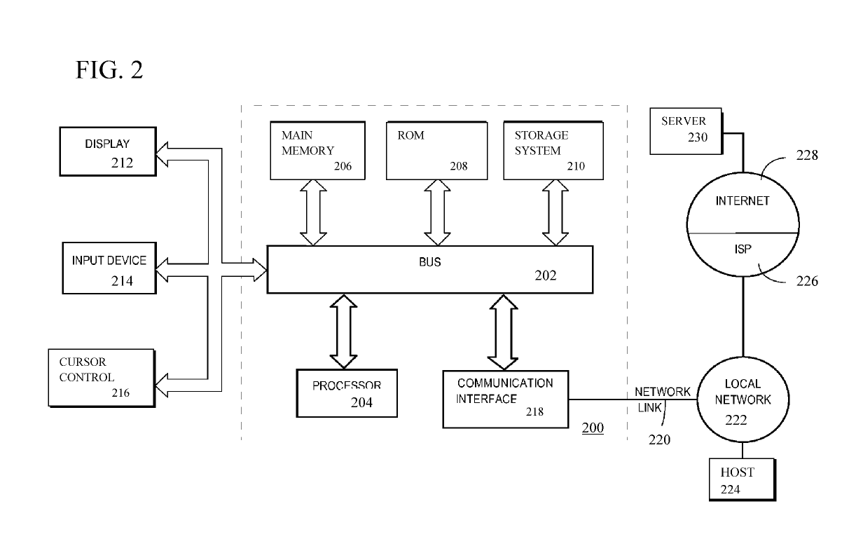

FIG. 2 is a block diagram of an exemplary computer system 200, according to some embodiments of the present invention. Computer system 200 includes a bus 202 or other communication mechanism for communicating information, a processor 204 coupled to the bus 202 for processing information, a main memory 206, such as a random access memory (RAM) or other dynamic storage device, coupled to bus 202 for storing information and instructions to be executed by processor 204. Portions of the main memory 206 also may be used as a cache for storing data to be immediately used, during execution of instructions to be executed by processor 204. In some embodiment, the cache memory may be separate from the main memory 206. Computer system 200 further includes a read only memory (ROM) 208 or other static storage device(s) coupled to bus 202 for storing static information and instructions for processor 204. A storage system 210, including a magnetic disk or optical disk, one or more SSDs, and other types of storage devices, is provided and coupled to bus 202 for storing information and instructions.

Computer system 200 may be coupled via bus 202 to a display 212, such as a liquid crystal display (LCD), for displaying information to a user. An input device 214, for example, a keyboard, a mouse, a pointing device and/or touch screen, is coupled to bus 202 for communicating information and command selections from the user to processor 204.

In some embodiments of the present invention, the techniques/processes of the invention are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In some embodiments, when processor 204 needs to read from or write to a location in main memory 206, it first checks whether a copy of that data is in the cache. If so, the processor immediately reads from or writes to the cache, which is much faster than reading from or writing to main memory 206. In some embodiments, the system 200 may include at least three independent caches: an instruction cache to speed up executable instruction fetch, a data cache to speed up data fetch and store, and a translation look-aside buffer (TLB) used to speed up virtual-to-physical address translation for both executable instructions and data. In some embodiments, the data cache may be organized as a hierarchy of two or more cache levels. However, embodiments of the invention are not limited to any specific combination of hardware circuitry and software, described above.

In some embodiments, when processor 204 needs to read from or write to a location in main memory 206, it first checks whether a copy of that data is in any of the storage devices.

The term “machine-readable medium” as used herein refers to any medium that participates in providing data that causes a machine to operate in a specific fashion. In some embodiments implemented using computer system 200, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red file communications. All such media must be tangible to enable the instructions carried by the media to be detected by a physical mechanism that reads the instructions into a machine.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a computer network, such as the Internet and store the file to main memory 206, from which processor 204 retrieves and executes the instructions. The instructions received by main memory 206 may optionally be stored on storage device 210 either before or after execution by processor 204.

Similarly, storage media may include but is not limited to one or more of the following—RAM (Random Access Memory), battery backed RAM, HDDs (Hard Disk Drives which can include magnetic disks and optical disks), HHDD (Hybrid Hard Disk Drives), tape drives, SSDs (Solid States Drives), separate storage systems such as SANs (Storage Area Network devices), NASs (Network Attached Storage devices), or remote storage such as cloud storage. SSDs typically have faster access speed than the HDD. One of the storage components in the system can be selected for storing data based on the frequency with which the data is accessed. In some embodiments, the DRAM and/or SSD can be used as a cache or storage for data that is frequently accessed from the HDD. In some embodiments, there may be different HDDs where some are faster than others and the faster HDDs can be used as a cache or storage for data that is frequently accessed. This will result in data requests being completed much faster.

In some embodiments, if a volatile storage such as RAM (non-battery backup RAM) is used for a tiered storage, then the above configuration may also be used as cache to keep the data in a non-volatile storage area.

Computer system 200 may also include a communication interface 218 coupled to bus 202. Communication interface 218 provides a two-way file communication coupling to a network link 220 that is connected to a local network 222. The communication interface 218 sends and receives electrical, electromagnetic or optical signals that carry digital file streams representing various types of information.

Network link 220 typically provides file communication through one or more networks to other file devices. For example, network link 220 may provide a connection through local network 222 to a host computer 224 or to file equipment operated by an Internet Service Provider (ISP) 226. ISP 226 in turn provides file communication services through the world wide packet file communication network now commonly referred to as the “Internet” 228. Local network 222 and Internet 228 both use electrical, electromagnetic or optical signals that carry digital file streams. The signals through the various networks and the signals on network link 220 and through communication interface 218, which carry the digital file to and from computer system 200, are exemplary forms of carrier waves transporting the information.

Computer system 200 can send messages and receive file, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In some embodiments, the techniques or methods described herein may be performed by any computing device. Examples of computing devices include, but are not limited to, computer systems, desktops, laptops, mobile devices, servers, kiosks, tablets, mobile phones, game consoles, or any other machine which includes hardware used for performing at least a portion of the methods described herein. For example, the computer devices may include some or most of the components of the computer system depicted in FIG. 2.

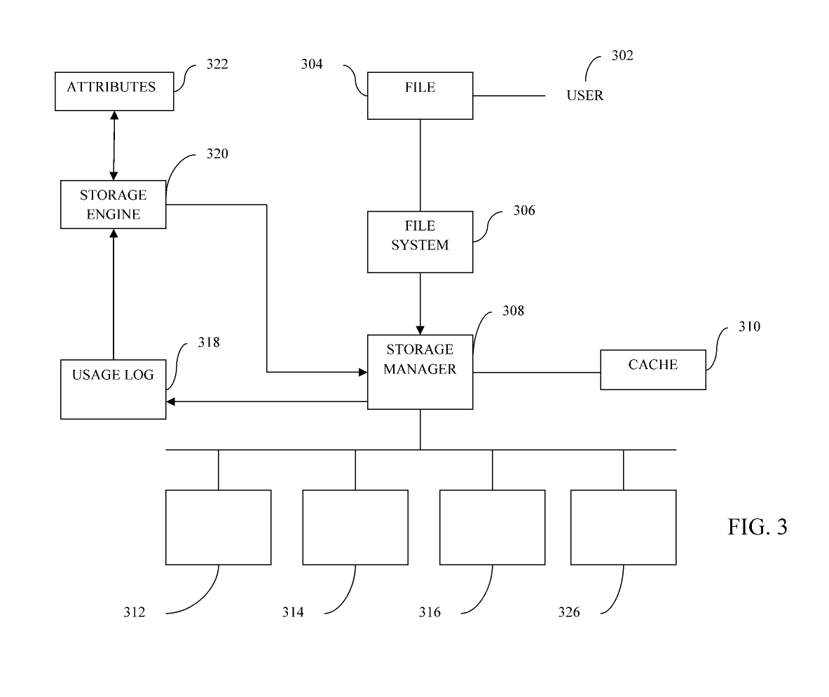

FIG. 3 is an exemplary simplified system block diagram for tiered storage management, according to some embodiments of the present invention. System 300 manages storage and allocates the data to a most appropriate (e.g., networked) storage system/device, based on some user, system, and/or file attributes, according to some embodiments of the present invention. As shown, system 300 includes a file system 306, a file Storage Manager 305 and/or a storage manager 308, a cache medium (memory) 310, a storage engine 320, a first SSD 312, a second SSD 314, one or more SAS disk drives 316, one or more SATA disk drives 326, and possibly other types of storage media. The cache medium 310 may include different level/types of memory components, such as a combination of RAMs and SSDs. System 300 may also include other components which, although not shown, may be used for implementation of one or more embodiments. Each of the storage components may be located on the same device or may be located on separate devices coupled by a network (e.g., Internet, Intranet, Extranet, Local Area Network (LAN), Wide Area Network (WAN), etc.), with wired and/or wireless segments or on separate devices coupled in other means. In some embodiments of the invention, the system is implemented using a client-server topology. In addition, the system may be accessible from other machines using one or more interfaces. In some embodiments, the system may be accessible over a network connection, such as the Internet, by one or more users. Information and/or services provided by the system may also be stored and accessed over the network connection.

Files 304 created or being used by a user 302 are managed by the file system 306 via the file storage manager 305 and sent to the storage devices 312, 314, 316 or 326 for storage in or data retrieval from the storage devices, via the storage manager 308. Tiered storage processing can be done by the file storage manager 305, the storage manager 308, or possibly a combination of both.

The file storage manager 305 compiles a usage log 318 of the files or data being stored to or retrieved from the storage devices via the file system 306. This includes the user, application or the operating system that handled (requested) the data, the time of the data request, the time it took the data request to be processed, time of data in the storage device, data removed from the storage device, and the like. The usage log 318 is then used by the file storage engine 305 to generate a variety of different attributes 322. The generated attributes are then used by the file storage manager 305 to store the data into or remove the data from the storage devices (including cache) via the file system, based on some parameter/attributes.

The storage manager 308 compiles a usage log 318 of the data being stored to or retrieved from the storage devices including the application or the operating system that handled (requested) the data, the time of the data request, the time it took the data request to be processed, time of data in the storage device, data removed from the storage device, and the like. The usage log 318 is then used by the storage engine 320 to generate a variety of different attributes 322. The generated attributes are then used by the storage manager 308 to store the data into or remove the data from the storage devices (including cache), based on some parameter/attributes. Some types of attributes 322 that are used by some embodiments of the present invention are explained in more detail below.

The file(s) 104 and/or 304 generally represents any data that is to be stored in or accessed from the cache or the storage system. The file(s) may be a system file, an application file, a data file, and/or any other file or collection of data that is logically considered a single collection of information. The file(s) may represent a file on a virtual system received for storage on virtual storage memory space (corresponding to physical storage memory). In some embodiments, the file(s) is associated with one or more attributes. Attributes associated with a file may include file attributes, environment attributes, etc. File attributes generally represent any characteristic of the file. For example, a file attribute of a file may be the file type. Examples of files types include executable files, data files, image files, video files, text files, system files, configuration files, developer files, etc. or any other possible file types. The file type associated with a file may be the particular type such as a bitmap image file or a JPEG image file, or the file type associated with a file may be a category of the file such as an image category (which includes both bitmap image files and JPEG image files).

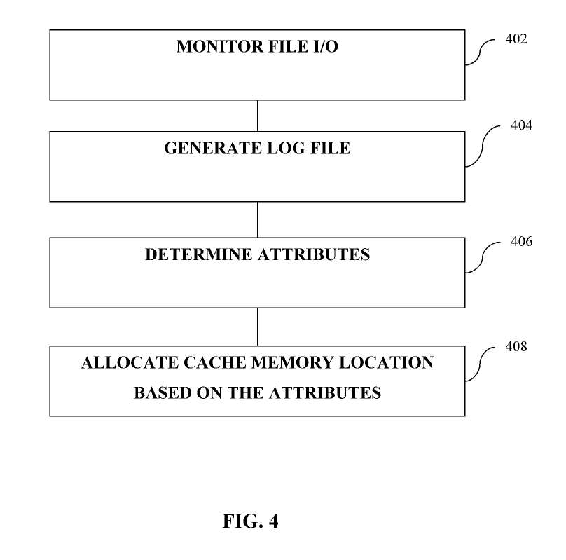

FIG. 4 is an exemplary process flow for tiered caching, according to some embodiments of the present invention. As shown, in block 402, the file I/O activities are monitored and a log file of the activities is generated in block 404. The invention then determines a plurality of attributes from the information in the log file, in block 406. The information in the log file may also be combined with other information, such as time and date, the status of the system, user inputs, an I/O activity and its time which are related to some specific event such as I/Os during systems startup, I/Os after shutdown has begun, I/Os related to a specific application or a process, certain type of I/Os such as I/Os related to temporary files In block 408, cache memory is allocated based on the one or more attributes. The allocation may include adding data to the cache, moving data in the cache, and/or removing data from the cache. In addition, data may be recovered from the main memory or secondary memory from the copy of the data in the cache, in case of a data loss.

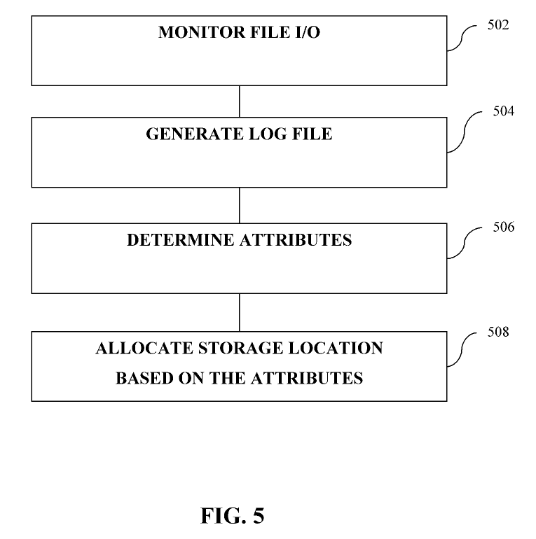

FIG. 5 is an exemplary process flow for tiered storage, according to some embodiments of the present invention. As shown, in block 502, the data I/O activities are monitored and a log file of the activities is generated in block 504. The invention then determines a plurality of attribute from the information in the log file, in block 506. The information in the log file may also be combined with other information, such as time and date, the status of the system, user inputs, an I/O activity and its time which are related to some specific event such as I/Os during systems startup, I/Os after shutdown has begun, I/Os related to a specific application or a process, certain type of I/Os such as I/Os related to temporary files, and other attributes. In block 508, tiered storage is allocated based on the one or more data attributes as well as one or more storage attributes. The allocation may include adding data to, and/or moving data from one type of storage tier to another type based on different attributes. In addition, data may be recovered from the main memory or secondary memory from the copy of the data in the cache, in case of a data loss.

There are a few concepts of tiered storage. One concept is that there are separate logical volumes and LUNs set up for each tier and then have to determine what data goes into each volume/LUN. The other concept is that there is a virtual volume set up that consists of the mixed devices and within that Virtual Volume, it is determined where the different tiers are. For example. One region points to the fastest storage, another region points to next fastest and so on. In some embodiments, the storage architecture is split into different categories or tiers. Each tier may vary in type and performance of hardware used, the amount of available storage, the availability of and policies at a tier and other system and/or hardware attributes.

One tiered storage model is to have a primary tier with expensive, high performance and limited storage, and a secondary tier which consists of less expensive storage media (e.g., disks). The primary and secondary tiers may then be augmented by a tertiary (backup) tier, wherein the data is copied into long term and possibly offsite storage media.

File attributes and/or data attributes may also include any classification or categorization of the file. For example, a file used exclusively during a boot up process may be categorized as a boot-up file, or some data (part of a file) may get accessed a lot, so that data (i.e., a portion of the file) is put into cache, or in the case of storage, in a higher performance tier. In some embodiments, a file attribute (dynamically) changes after creation of the file. For example, a user associated with a file may be changed or content within the file may be changed. Another example of a file attribute includes prior use of the file or usage statistics. An attribute related to a prior use of a file may indicate a process that owns/controls the file, an application that requests storage of the file or requests access to the file, an access frequency associated with the file, a number of processes that have shared the file or are currently sharing the file, whether the data is being more often read from or written to, a user associated with the file, content or information contained in the file, an age of the file, a number/size of other files associated with the file, etc.

In some embodiments, the file(s) is associated with attributes that are environment attributes, in addition to or in alternative to file attributes. Environment attributes generally represent any characteristics associated with an environment in which the file is stored, accessed, modified, executed, etc. An example of an environment attribute includes the available storage memory space in the storage system, in which the file(s) is stored or to be stored. Another example of an environment attribute may be an operating system managing the file. Environment attributes may also include a geographical region in the world in which the computer system accessing the file is located. Environment attributes may include a use context. For example, an environment attribute may indicate whether the file is being accessed, modified, etc. by a student for an educational purpose or by an employee for a professional purpose. Environment attributes may include the number of users accessing the computing system that is managing the file(s) or the number of users with permission to modify the file. Environment attributes may include any other characteristics of an environment associated with the file(s). In some embodiments, other attributes such as access times, write level thresholds and attributes related to the different tiers may also be considered.

In some embodiments, files are grouped together based on one or more common attributes, for example, one or more file attributes, and/or one or more environment attributes, etc.). Statistics associated with a group of files, having a particular attribute, are used to identify attribute patterns associated with the attribute. Attribute patterns generally include any data derived from the statistics. Attribute patterns may include data determined by performing computations based on the statistics, detecting patterns in the statistics, etc. All the statistics associated with a group of files or a portion of the statistics associated with the group of files may be used to detect patterns. For example, outliers or data points that are substantially different from a set of data may be discarded before detecting patterns in the statistics.

In some embodiments, the present invention determines what data to store or retain in, and/or remove from the cache. Data, as used herein, may refer to actual data, data type, file type, and/or data block. The invention determine what data is used most frequently for read and/or write activity and determine what data is removed (i.e., TRIM or deletion) most frequently from the cache. If certain data is known to get removed often (i.e., temporary data, such as a browser's temporary files), then that data may not be stored in the cache or a more appropriate medium e.g., (cheaper, more efficient, and possibly slower) may be for this types of cache. In one example, grouping deleted data together can be more efficient on some storage devices. In some embodiments, the present invention determines which data is used most frequently based on previous usage pattern, past utilization and time of utilization, current utilization and time of utilization, current and past average utilization and the time duration of the utilization, current and/or past average utilization and the time of the utilization, for example, data is moved or copied to a faster access location based on utilization and the time of day or prior to a scheduled time.

In some embodiments, the present invention determines a variety of attributes of the data and of the storage mediums, and any environmental attributes to determine what data should be place in what storage tier or medium. For Example, data that is being highly read accessed will go to storage that has high read access performance. This can happen dynamically too as data that was highly accessed, but then later has not been accessed for some time, will get moved to slower performance media type and vice-versa. Data being highly written to/updated will go to storage that handles write performance, longevity, and reliability better.

In some embodiments, the present invention determines what data is needed for specific events. Examples of events include, but are not limited to: system startup, system shutdown, system hibernate, system restore from hibernate, application startup, application shutdown. For example, data is moved or copied to memory or storage locations that have a faster access speed than a current memory location where the data is stored, prior to any of the above events. Data to be used in a system startup or restore procedure is stored in fast-access memory (e.g., a cache) during a system hibernate procedure. Data to be used in an application startup is stored in fast-access memory (e.g., a cache), or storage medium, when it is known when that application will be used. In some embodiments, data usage statistics may indicate that whenever a system starts up, a user normally starts up a certain application “A” soon after. Based on the data usage statistics and the anticipated use, data associated with application “A” is stored into cache, or faster storage.

In some embodiments, the present invention determines what applications are being used most frequently and classify these applications and/or the related data that these applications reference as high usage data. For example, data associated with a frequently used application is cached in fast-access memory (e.g., a cache), or stored in a fast-access storage medium, even though that particular data may not be used frequently. In a gaming example, all data associated with a particular level of the game may be cached into fast-access memory because the user is accessing the level. The data cached in fast-access memory may or may not have been frequently used before. Furthermore, the data cached in fast-access memory may or may not have been in a data block that was frequently accessed before. The selection of particular data for caching in fast-access memory may be based on association with a frequently used application or based on an association with a frequently used feature, level, document, etc., regardless of whether or not that particular data is frequently used.

Similarly, in the example of gaming, all data associated with a particular level of the game may be stored in a fast-access storage so it may be retrieved and stored into a fast cache. Less frequently accessed data may be stored in an inexpensive (potentially slower storage). All data associated with a particular level of the game may be may be stored in a fast-access storage so it may be retrieved and stored into a fast cache. Less frequently accessed data may be stored in an inexpensive (potentially slower storage).

In some embodiments, the present invention determines which data is needed for hibernation and resume, and/or which data is needed by Boot Loader in an early boot cycle. This determination is done by both knowledge of the start-up procedure and logging of what files or data are accessed during previous occurrences of these events. For example, if an HDD is set up as the system drive (e.g. with Windows™ OS installed on it), then the system still needs to spin up the HDD to read the boot files from it, which takes time, to complete the boot-up. In some embodiments, the boot loader files are cached or stored in a faster memory (for example, a SSD) that does not have some of the (startup) performance restrictions of an HDD so that the system can boot up using the cached boot loader files without necessarily spinning up the HDD.

In some embodiments, the present invention preloads specified data into cache, or in the case of tiered storage, in a fast-access storage medium, so when the user first starts the system, this data is already in the cache, or can be accessed quickly from the fast-access storage medium. One example is for system builders to preload certain data into cache so related events such as application startup performs fast on the first system startup. In some embodiments, the present invention pins (permanently stores) data into cache or faster storage medium, based on hard coded information, such as system builder selection, administrator selection, and/or user selection. The pinning can be effective on the blocks that are not part of normal user data such as MBR, GPT, boot records, file system metadata, hibernation file etc. In an example, in which the system builder or the user wants fast response of the builder's system tools when the user powers up the system for the very first time, the application and/or the data can be pinned into the cache, or pinned into the fast-access storage medium so that the data can be preloaded into the cache, for this to occur. In some embodiments, the present invention determines what data to store and where to store the data by any combination of the above methods.

In some embodiments, data can be added to, or moved (or removed from cache) from the cache or the storage locations, based on a period of time between data accesses. For example, if it is known that, when some data got accessed in the past, the access rate was high for period of time then the access slowed down, the invention then would add more weight on keeping, moving, or removing that data cached or stored, after a certain period of time or event. In one example, data is moved or copied to a new memory or storage location with a faster access speed than a current memory location of the data, based on time of day or prior to a scheduled time or event.

In some embodiments, data is cached or stored based on a period of time between data accesses in a time window not simply a frequency of data access in a time window. In an example, a time window over which data accesses are monitored is one hour long. In this example, data A may be accessed every two minutes during the entire hour long time window, totaling 30 accesses (60 minutes divided by two). Data B may be accessed thirty times in a particular minute of the hour but not accessed in the other fifty-nine minutes of the hour. Data B is cached or stored the next time data B is accessed, however, data A is not cached or stored the next time data A is accessed even though both Data A and Data B are accessed an equal number of times during the monitoring process in the hour long monitoring time window. This is because the access time between each access to data A within the monitoring time window averages to two minutes. In contrast, since all thirty accesses to Data B were within one minute the access time between each access to data B is only a couple seconds.

This computation indicates that when data B is accessed, data B is heavily accessed and therefore data B should be cached after the first access request since there will be many subsequent requests. Furthermore, this information is used to deduce that when data A is accessed, the likelihood of data A being accessed soon is not very high. Using the period of time between data accesses to select data for storage in cache (or stored in higher performance devices) increases the number of hits for data stored in cache or storage medium, because the data that is accessed heavily when it is being used is selected for storing in cache or faster storage medium, whereas the data that is not accessed as heavily is not stored in cache or in the faster storage medium.

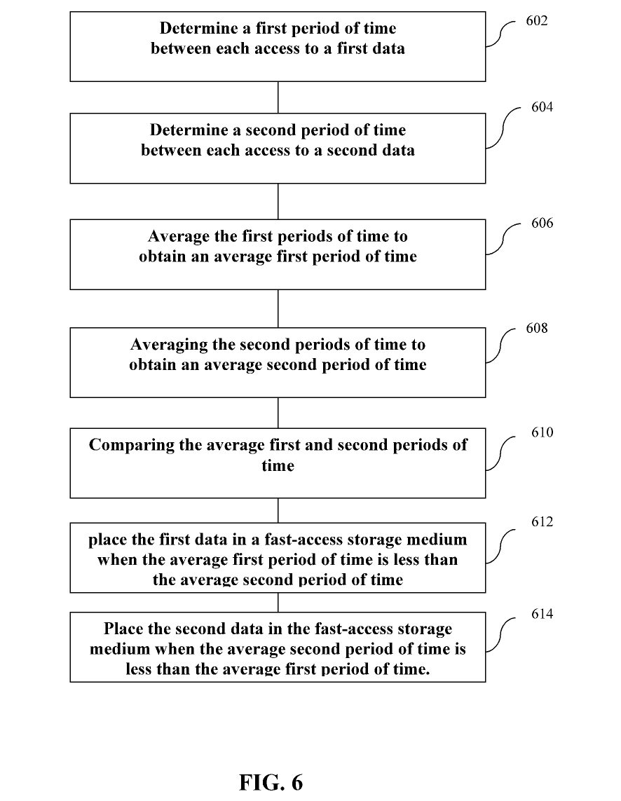

FIG. 6 is an exemplary process flow for data placement, according to some embodiments of the present invention. As shown in block 602, a first period of time between each access to a first set of data (e.g., a file or a portion thereof) is determined in a time window by monitoring the accesses to the first data set. In block, 604, these first periods of time between each access are then averages to obtain an average first period of time between the data accesses to the first data set. In block, 606, a second period of time between each access to a second set of data (e.g., a file or a portion thereof) is determined in the same time window by monitoring the accesses to the second data set. The second periods of time between each access to the second data set is then averaged to obtain an average second period of time, in block 608. The average first period of time is compared to the average second period of time, in block 610. The first data is placed in a fast-access storage medium, when the average first period of time is less than the average second period of time, in block 612. Alternatively, the second data is placed in the fast-access storage medium, when the average second period of time is less than the average first period of time, in block 614. The storage medium may be a tired cache or a tiered storage medium. In the case of a tiered storage, placing the data is storing the data in the tiered storage. In the case, of tiered cache, placing the data is caching the data in the tiered cache. Moreover, based on some attributes (discussed above and below), the data may be placed in an appropriate cache tier or storage tier.

In some embodiments, the average first (and/or second) period of time is compared to one or more set threshold to determine the placement of the data.

In some embodiments, a period of time between data accesses and a historical usage of the data may be used to determine if and when to remove data from cache. In an example, monitoring access to data B may indicate that data B is historically accessed every one or two seconds when data B is being used. When data B is not being used, data B may not be accessed for hours. This historic information may be used to deduce that if data B is not accessed for five minutes (or some other threshold), then data B is likely not being used. Responsive to deducing that data B is likely not being used, data B can be removed from the cache. Accordingly, the time window between access times can be used to remove data from cache based on a prediction that the data will not again be used for a while.

In some embodiments, the storing of particular data in cache and/or the removal of particular data from cache can be based on thresholds selected based on the historic usage of that particular data, instead of generic thresholds for all data. For example, historic usage may indicate that data X is accessed every 1 to 2 seconds when data X is being used and data Y is accessed every 5 to 10 seconds when data Y is being used. When data X is stored in cache, the accesses to data X are monitored. If data X is not accessed for 10 seconds, then there is good chance data X is no longer being used because historically data X is accessed every 1 to 2 seconds. In response to determining that data X has not been accessed for 10 seconds, data X can be removed from cache (e.g., overwritten, flagged for removal or replacement, or otherwise deleted from cache).

The threshold of non-use for removing data X from cache is based on the historical use (every 1 to 2 seconds) of data X. When data Y is stored in cache, the accesses to data Y are monitored. Even if data Y is not accessed for 10 seconds, it is still unclear whether data Y is being used. If data Y is not used for 100 seconds, then there is good chance data Y is no longer being used because historically data Y is accessed every 5 to 10 seconds. In response to determining that data Y has not been accessed for 100 seconds, data Y can be removed from cache (e.g., overwritten, flagged for removal or replacement, or otherwise deleted from cache). The threshold of non-use for removing data Y from cache is based on the historical use (every 1 to 2 seconds) of data Y. Different thresholds can be used for storing data, moving data, or removing data from the same cache based on a historic usage of the particular data being added or removed from cache.

In some embodiments, a period of time between data accesses and a historical usage of the data may be used to determine which optimum storage tier(s) the data should reside at. In an example, monitoring access to data B may indicate that data B is historically accessed every one or two seconds when data B is being used. When data B is not being used, data B may not be accessed for days. This historic information may be used to deduce that if data B is not accessed for five minutes (or some other threshold), then data B is likely not being used and likely not to be used for days, the data becomes a candidate for moving to a slower and/or cheaper (optimum) storage tier if the faster storage tier is needed for data being actively used right away. Accordingly, the time window between access times can be used as a threshold to move data between storage tiers based on a prediction that the data will not again be used for a while. Different thresholds can be used for storing data, moving data, or removing data from the storage tiers based on a historic usage of the particular data.

In some embodiments, the present invention keeps track of all the data classification, attributes, usage, and access patterns that is efficient not only in speed, but also for the type of storage media it resides on. For example, data that is getting read heavily and is stored on some slow storage media will benefit from caching on a faster device, but data that is getting written heavily may not benefit from being cached because the storage media it resides on processes writes very efficiently. The data getting heavily modified could be stored in a cache media favoring writes such as RAM or SLC based SSD. The files has small life time yet get created and deleted often can be stored in a less permanent cache media, data that are related to a specific application or process can be cached or stored closely together or combination of other attributes.

In some embodiments, the present invention determines where to place the data being cached or stored according to characteristics of the storage media (e.g., performance and/or longevity) and classification of the data, as described above in detail. For example, the invention may determine what data is getting accessed the most, determine what storage medium or portion of storage medium has the fastest access times, and the place a copy of that data to be used as a cache in the fastest storage medium or the portion of the storage medium.

In some embodiments, the present invention organizes cached or stored data on a storage medium. The storage medium may be selected to be used as storage for cached or stored data. Within the selected storage medium, the cached or stored data can be organized so it can be processed faster and more efficiently. In one example, different zones may be set up for different categories of data, based on environmental and/or file attributes. This can include, but not limited to one or more of zone for boot startup data, zone for boot loader data, zone for hibernation data, zone for general access data, zone for pinned data, zone for heavily write accessed data, zone for heavily read accessed data, zone for heavily write and read accessed data, and/or zone for temporary data. For example, a zone for heavily write accessed data will be placed on storage media that does not have a write lifetime threshold, such as HDDs. Another example is a zone for extremely heavily read data to be set up in RAM, while a zone for heavily accessed data is set up on an SSD.

In some embodiments, the present invention uses the cache for data redundancy and/or recovery. For example, if the original data has been invalidated or corrupted for some reason but a copy of the original data still resides in the cache, the data can be restored, using the data in the cache. In some embodiments, when the storage medium containing the original data is non-functional or the data is corrupted; any cached data from this non-functional storage medium could be restored to another location.

In one example, the invention receives a request for data stored on a hard disk drive; stores a copy of the data in a cache that is separate from the hard disk drive; subsequent to storing the copy of the data in the cache, determines that the data stored in the hard disk drive is corrupt; and accordingly restores the data on the hard disk drive based on the copy of the data in the cache.

In some embodiments, the present invention improves storage allocation by pre-fetching data into a faster storage medium, such as a cache. For example, where an SSD is being used to store cached data, in addition to a RAM in case of tiered caching, for driven events such as system or application startups, data that is known to be accessed during this event can be pre-fetched from the SSD into RAM for faster access. In one example, data used during boot-up is cached on the SSD, which is a persistent cache. In some embodiments, the present invention improves storage allocation by pre-fetching data into a faster storage medium, such as a cache. For example, where an SSD is being used to store data for driven events such as system or application startups, data that is known to be accessed during this event can be pre-fetched from the SSD into RAM for faster access. In one example, data used during boot-up is stored on a fast medium such as a SSD.

On boot-up, the cached data is preloaded from the SSD into a DRAM (which is faster than the SSD). For example, since SSDs are non-volatile, then data needed at boot-time can be read quickly during Boot-up from a SSD (rather than the HDD) and then put into the RAM cache which is faster than the SSD. However, RAM is volatile, so it cannot be retained during a system restart. Now that this data is already pre-fetched into the RAM cache, the boot-up process can read it quickly and boot up faster

In some embodiments, the present invention improves storage allocation and/or longevity with write caching. For example, the invention uses the cache to queue data before it is written to the final storage (tier) location. Characteristics of the data and the final storage device or tier will determine what data to queue and how to write it to the storage device or tier. For example, SSDs do not typically have a good performance (speed) for write operations. In this case, the invention captures several write operations for small blocks of related data into the cache, consolidates them into a single (or fewer) write operation using a single (or fewer) data blocks and then writes that single (or fewer) data block to the SSD. This enforces larger sequential writes to occur which are more efficient than smaller random writes. For example, for an application that is performing small sequential writes to a log file, this will gather the small writes and perform a large sequential write which will be faster and more efficient.

In some embodiments, the write-back caching is performed, only if a battery back for the storage medium is detected, to ensure integrity of the data.

In some embodiments, the present invention keeps, moves, or removes the data in the cache updated, based on user input. In some embodiments, the present invention keeps, moves, or removes the data in the storage medium, based on user input. For example, a user may set his/her personal preferences to execute a particular application or display particular data. Based on the user's preferences, data may be pinned to cache or the storage medium, or removed from the cache to speed up the performance for that particular user.

In some embodiments, the present invention detects data that is being read from or written to storage medium or the cache that has a repetitive pattern. When this type of data (with a repetitive pattern) is detected, a compressed copy of the data and its characteristics are cached or stored in a tiered storage medium. Subsequent requests of the data can be cached or accessed, using the storage medium with the faster access time. For example, data that is read from or written to one or more storage media has a repetitive pattern such as “123412341234 . . . 1234”. In this case, the repetitive pattern is “1234”. A data set describing this data may include an address identifier such as a LBA (Logical Block Address) or a storage location where the repetitive data resides at, the repetitive pattern (1234 in this case), and the number of times the pattern is repeated. This (compressed) data set may then be stored in the storage media.

In some embodiments, the present invention receives a request for data stored in a storage device (which could be an HDD or SSD or some other form of storage) specified by a logical block address (LBA) or a storage location; retrieves data from storage device based on the LBA or storage location and provide the data; determines that the data includes a repetitive pattern; stores in a cached data structure that has higher performance attributes: (a) one iteration of the repetitive pattern, (b) the number of times the iteration is repeated, and (c) the LBA or the storage location that identifies where the data starts; receives a second request for the data specifying the same LBA or storage location; and determines if the request is stored in the cached data structure. If the LBA or storage location is found in the cached data structure, provide the data from that cached data structure using the stored pattern and the number of times the pattern is repeated which will complete the read much faster as it does not have to read the whole data structure from the original storage location.

In some embodiments, the present invention receives a request to write data to a storage device at a location specified by a LBA or a storage location; determines if the write request is stored in the cached data structure; if the LBA or the storage location is not found in the data structure, writes the data to the storage device at the location specified by LBA or storage location; if a repetitive pattern, replaces the data with: (a) one iteration of the repetitive pattern, (b) the number of times the iteration is repeated, and (c) the LBA or the storage location that identifies where the data starts; if the LBA is found in the cached data structure, then determines whether or not the repetitive pattern matches the pattern in the compressed data structure; if a repetitive pattern and different than what is in the compressed data structure, then updates the compressed data structure. If a repetitive pattern and same as in the compressed data structure and within known size, then skips any update, if not, a repetitive pattern then invalidates the compressed data structure and writes the data in a non-compressed format. If the pattern matches then take no further action; and if the pattern does not match, then updates the compressed data structure with the new pattern. In some embodiments, the data can still be cached, but what will be cached is the Data Pattern Compression (DPC) data structure that is on the tiered storage.

In some embodiments, the present invention makes sure the data in a persistent cache is still valid after a shutdown. One example of a persistent cache is where the cache resides on an SSD (or other NVMs), where the data will remain upon a power shutdown. For example, during shutdown, when data stored in cache is validated against corresponding data stored at a data source, the data in the cache is considered valid, if the data stored in cache validates against the data stored at the data source, then the data in the cache is considered valid. If the data stored in the cache does not validate the data stored at the data source, the data in the cache is considered invalid data. The invalid data in cache may be marked invalid or replaced, during shutdown of a system, with corresponding data from the data source. In one example, the data stored in cache is not itself necessary for the shutdown process, but rather validated during shutdown for use by the system during or after a subsequent startup.

In some embodiments, data in cache or predefined storage location is validated upon startup. For example, during startup, data stored in cache is validated to corresponding data stored at a data source. If the data stored in cache validates against the data stored at the data source, then the data in the cache is considered valid. If the data stored in the cache does not validate against the data stored at the data source, the data in the cache is considered invalid data. The invalid data in cache may be marked invalid or replaced, during startup of a system, with corresponding data from the data source. In one example, the data stored in cache is not itself necessary for the startup process, but rather validated during startup for use by the system after the startup (for example, by applications or the operating system). If data in cache is valid, then the data in the cache can be used.

In some embodiments, the present invention uses a digest, a signature or a time stamp of a journal or log file content of a file system to compute file system signature and utilizing it at the shutdown and the system start up to validate data in the cache. For example, the invention monitors the file system log file, takes a digest or signature (using known methods) of the log file, before a system shut down, at the system startup, the invention then compares the digest or signature to the digest or signature taken during the shutdown. If the digest or signature does not match, then invalidate the cache, if the signature or digest matches then continue the normal operation.

In some embodiments, the present invention saves the data signature at the shutdown which will be compared again at the startup of the system. In some embodiments, the method and system of the present invention generate a first data signature associated with a shutdown procedure from the cache data and/or data source which the cached data is based on during shutdown; generate a second data signature associated with a startup procedure from the same cache data and/or data source during startup; compare the first data signature(s) with the second data signature(s) to determine whether they match; and responsive to the first data signature matching the second data signature, validating the data source that the cached data is based on has not changed during or after the startup.

In some embodiments, the present invention utilizes partition and file system signature to verify the data change in a storage device, and/or utilizes write block count (SMART data) to determine a data change. This SMART data if available will indicate if any data has been written to the disk since the last time the data in the cached was saved and verified. This will be used to determine if the cache data is still valid.

In some embodiments, in a case of unexpected system shut down (e.g., unexpected power failure), the present invention validates the data in a persistent cache (for example, an SSD being used as a cache). The system and method of the invention check the cached data to see if it is still valid, using methods described above; if the cached data is valid, the data is validated for cache use, if not, the data is invalidated for cache use. In some embodiments, the invention uses a dirty flag and sets the file system dirty at the mount and setting the files system as good at dismount.

In some embodiments, the present invention improves system start up times where the system volume is on an HDD by eliminating the time to wait for the HDD to become available for use. The system start up can include, but not limited to a cold system start-up or a resume from hibernation. In some embodiments, the invention uses a device that does not have such a limitation, such as an SSD to cache or store specific boot files to allow the system to start up without waiting for the HDD System Volume to spin up. In an example, boot loader files are stored on the SSD for use during boot up such that the system does not need data from an HDD to boot up.

In some embodiments, the invention is set up as an aftermarket product. For example, a user may install a storage media, such as an SSD, to be used for caching. In one example, this could be an internal SSD or an external SSD. In some embodiments, the invention utilizes user assisted detection and utilization of the SSD for caching. Determining how large of an SSD is needed or/how much of an SSD should be used can be done by one or more of the following: total amount of storage being used; type or version of OS being used; types of applications on the system; type of activity occurring on the system; automatic detection and utilization of the SSD for caching; and providing guidance and or assistance to finding and obtaining proper caching media.

In some embodiments, the amount of storage needed on a virtual storage system grows, more physical storage can be added to it. The invention then notifies the user that more storage is recommended and what type of storage (i.e. for what tier) is needed for optimal performance, based on one or more of the attributes of the data and the storage tiers (media types) and the capacities which are being used.

Since the storage of some devices, for example, a mobile phone is limited by the amount of storage on that mobile device, the user may add remote/cloud storage, but user now has to also decide what data to keep local (on the device) and what data to store remotely on the cloud storage. In some embodiments, the invention keeps a file pointer on the local storage that points to where data is located on the remote storage. For files that have not been accessed for a (predetermined) period of time, the files can be moved to the remote storage and a file pointer remains on the local storage. However, to the user, all the data still appears to be on the local storage. When the user accesses such data or files, the invention reads them from the remote storage to local storage and then may keep them local until the data of the files are marked to be moved to the remote storage again. This allows users to have (or appear to have) more local storage space than they really have and thus the users do not have to determine what data should reside locally or remotely.

In some embodiments, besides automatically moving data between storage tiers according to the changing file attributes, the invention handles the case when a tier fills up. In this case, the invention selects the data to be stored at a different tier and optionally, warns the user if more storage is needed at a specific tier.

In some embodiments, the invention is capable of measuring the performance gained by a caching or storage technology by one or more of the following:
1. Determining performance gain based on time taken for each JO to the HDD and the time taken for each JO to the SSD: A write or read request is executed on an HDD. The response time for the request is measured to determine a length of time needed to perform the operation by the HDD. A same request is executed on a SSD. The response time is measured to determine a length of time needed to perform the operation by the SSD. The response times are compared to determine a performance gain for using the SSD instead of the HDD.
2. Determining performance gain based on average time taken for IO to the HDD and the average time taken for each IO to the SSD: A set of write or read requests are executed on an HDD. The response time for each request is measured to determine an average response time to perform the operations by the HDD. The same set of write or read requests are executed on a SSD. The response time for each request is measured to determine an average response time to perform the operations by the SSD. The average response times are compared to determine a performance gain for using the SSD instead of the HDD.
3. Determining performance difference between multiple devices and within the devices and using that information to determine performance improvement.
4. Determining performance gain using predictive performance of devices. For example, by gathering performance data on different areas of the storage device, it can be determined what the performance of the other areas should be: Information (for example, access speed, longevity, etc.) is obtained for a first set of regions on a storage device. Based on the information for the first set of regions on the storage device, additional information for a second set of regions on the storage device is computed where the first set of regions is different than the second set of regions. In one example, the information for a particular region is computed at least based on information of other regions close to the particular region or surrounding the particular region. In one example, an access speed for a particular memory location may be determined based on the mean or mode of the access speeds for memory locations near and/or surrounding the particular memory location.

It will be recognized by those skilled in the art that various modifications may be made to the illustrated and other embodiments of the invention described above, without departing from the broad inventive step thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for data placement, the method comprising:
determining a first period of time between each access to a first data, in a predetermined time window;
averaging the first periods of time between each access to obtain an average first period of time;
determining a second period of time between each access to a second data, in said predetermined time window;
averaging the second periods of time between each access to obtain an average second period of time;
comparing the average first period of time and the average second period of time;
placing the first data in a fast-access storage medium, when the average first period of time is less than the average second period of time; and
placing the second data in the fast-access storage medium, when the average second period of time is less than the average first period of time.

2. The method of claim 1, wherein the fast-access storage medium is a tiered cache and placing the data in the cache comprises of caching the data in the tiered cache.

3. The method of claim 2, further comprising using the average first period of time and the average second period of time and a historical access data for the first and second data to remove the first or second data from said tiered cache.

4. The method of claim 3, further comprising determining a threshold of non-use for each of the first and second data, from the historical access data for the first and second data, respectively and the non-use thresholds and the average first period of time and the average second period of time to remove the first or second data from said tiered cache.

5. The method of claim 2, further comprising determining which of the first or second data is accessed most frequently, based on one or more of previous usage pattern, past utilization and time of utilization, current utilization and time of utilization, and current and past average utilization and the time duration of the utilization; and moving the first or second data that is accessed less frequently from the tiered cache.

6. The method of claim 2, further comprising using the average first period of time and the average second period of time and a historical access to the first and second data to remove the first or second data from a first tier of said tiered cache to a second tier of said tiered cache.

7. The method of claim 2, further comprising comparing the average first period of time or the average second period of time to a threshold and placing the first or second data set in an optimum cache tier, if the average first or second period of time is below said threshold.

8. The method of claim 2, further comprising using the cached data in the tiered cache for one or more of data redundancy and recovery.

9. The method of claim 2, further comprising using a digest, a signature or a time stamp of a journal or log file content of a file system to compute a file system signature and utilizing the file system signature at a system shutdown or a system start up to validate the cached data in the tiered cache.

10. The method of claim 1, further comprising organizing the placed data in the fast-access storage medium for faster and more efficient processing by setting up different zones for different categories of data, based on data attributes.

11. The method of claim 1, further comprising using the placed data in the fast-access storage medium to queue data before the data is written to a final storage location, based on characteristics of the data; and block writing the queued data to the final storage location.

12. The method of claim 1, wherein the fast-access storage medium is a tiered storage medium and placing the data in the tiered storage medium comprises of storing the data in the tiered storage medium.

13. The method of claim 12, further comprising using the average first period of time and the average second period of time and a historical access data for the first and second data to place the first or second data to an optimum tier of said tiered storage.

14. The method of claim 12, further comprising comparing the average first period of time or the average second period of time to a threshold and placing the first or second data set in an optimum storage tier if the average first or second period of time is below said threshold.

15. A non-transitory computer readable storage medium comprising one or more of instructions, which when executed by one or more processors cause:
monitoring a first period of time between each access to a first data, in a predetermined time window;
averaging the first periods of time between each access to obtain an average first period of time;
monitoring a second period of time between each access to a second data, in said predetermined time window;
averaging the second periods of time between each access to obtain an average second period of time;
comparing the average first period of time and the average second period of time;
placing the first data in a fast-access storage medium, when the average first period of time is less than the average second period of time; and
placing the second data in the fast-access storage medium, when the average second period of time is less than the average first period of time.

16. The non-transitory computer readable storage medium of claim 15, wherein the fast-access storage medium is a tiered cache and placing the data in the cache comprises of caching the data in the tiered cache.

17. The non-transitory computer readable storage medium of claim 16, further comprising instructions, which when executed by the one or more processors cause using the average first period of time and the average second period of time and a historical access data for the first and second data to remove the first or second data from said tiered cache.

18. The non-transitory computer readable storage medium of claim 17, further comprising instructions, which when executed by the one or more processors cause determining a threshold of non-use for each of the first and second data, from the historical access data for the first and second data, respectively and the non-use thresholds and the average first period of time and the average second period of time to remove the first or second data from said tiered cache.

19. The non-transitory computer readable storage medium of claim 15, wherein the fast-access storage medium is a tiered storage medium and placing the data in the tiered storage medium comprises of storing the data in the tiered storage medium.

20. The non-transitory computer readable storage medium of claim 19, further comprising instructions, which when executed by the one or more processors cause using the average first period of time and the average second period of time and a historical access data for the first and second data to place the first or second data to an optimum tier of said tiered storage.
